(19) United States
(12) Patent Application Publication
(10) Pub. No.: US 2016/0063320 A1
(43) Pub. Date: Mar. 3, 2016

(54) VIRTUAL BODY SCANNER APPLICATION FOR USE WITH PORTABLE DEVICE

(71) Applicant: Susan Liu, West Covina, CA (US)

(72) Inventors: Susan Liu, West Covina, CA (US); Tiffany Liu, West Covina, CA (US); Andy Liu, West Covina, CA (US)

(21) Appl. No.: 14/814,502

(22) Filed: Jul. 30, 2015

Related U.S. Application Data
(60) Provisional application No. 62/043,796, filed on Aug. 29, 2014.

(51) Int. Cl. G06K 9/00; G06Q 30/06; G01B 11/06; H04N 5/225; G01B 21/08

(52) U.S. Cl. CPC G06K 9/00369; H04N 5/2253; G01B 21/085; G01B 11/06; G06Q 30/0613

(57) ABSTRACT

A method for performing measurements includes taking a photograph, via a camera having a position association with a device, of any portion of a subject. The method also includes processing the photograph through a thermographic module to discern a measured portion. The method further includes comparing the measurement data to a stored comparison model to derive fitting data. The method also includes transmitting the fitting data from the device to a server.

### CROSS-REFERENCE TO RELATED APPLICATIONS

The present application claims the benefit of U.S. Provisional Application No. 62/043,796 filed on Aug. 29, 2014, entitled “VIRTUAL BODY SCANNER APPLICATION FOR USE WITH PORTABLE DEVICE”, the disclosure of which is incorporated by reference herein in its entirety.

### TECHNICAL FIELD

The present disclosure generally relates to software-based programs, code and systems that can be implemented and used in a wide array of devices. More specifically, the present disclosure relates to a virtual body scanner application for use with a portable device.

### BACKGROUND

The experience of shopping or online shopping for clothes, accessories, shoes and other similar merchandise can be cumbersome if size measurements of a consumer are not known beforehand. This can lead to measurements having to be taken in the store, the inefficient process of trying clothes on while shopping, and most wasteful for a business or merchant, the inevitable returning of purchased goods that simply do not fit the consumer.

There may also be applications that allow a user to take measurements of themselves before shopping in a store. However, using these applications takes time, requires time-consuming and cumbersome procedures such as arranging full-body shots, and such applications often lead to inaccurate results which may undergo a number of changes or revisions. Also, programs on websites may require the use of unrealistic animated representations that do not accurately reflect the realities of a consumer's body type or measurements. Therefore, the process of in-store or online shopping can be improved for both the consumer and the merchant by utilizing a tool that solves the above-described problems.

### SUMMARY

A method for performing measurements includes taking a photograph, via a camera having a position association with a device, of any portion of a subject. The method also includes processing the photograph through a thermographic module to discern a measured portion. The method further includes comparing the measurement data to a stored comparison model to derive fitting data. The method also includes transmitting the fitting data from the device to a server.

Another method for performing measurements includes taking measurements, via a camera having a position association with a device, of any portion of a subject. The method also includes comparing the measurements to a stored comparison model to derive fitting data. The method further includes transmitting the fitting data from the device to a server.

A computer-program product includes a non-transitory computer-readable medium having code for taking a photograph, via a camera having a position association with a device, of any portion of a subject. The computer-readable medium also includes code for processing the photograph through a thermographic module to discern a measured portion. The computer-readable medium further includes code for comparing the measurement data to a stored comparison model to derive fitting data. The computer-readable medium also includes code for transmitting the fitting data from the device to a server.

A device includes a camera configured to take a photograph, the camera having a position association with the device. The device also includes a thermographic hardware module coupled to the camera to process the photograph into measurement data. The device further includes an application hardware module coupled to the thermographic hardware module and the camera configured to compare information with a stored comparison model to derive fitting data, the information comprising the photograph and measurement data. The device also includes an internet connection hardware module configured to transmit the fitting data to a server.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIGS. 1A-1B show illustrations depicting a typical camera measurement procedure where a full-body shot of a subject is taken with a device having an equipped camera.

FIGS. 2A-2B show illustrations depicting a camera measurement procedure where any portion of a subject is taken with a device having an equipped camera, according to aspects of the disclosure.

FIG. 3A shows a sophisticated comparison model being compared to a subject portion profile, according to aspects of the disclosure.

FIG. 3B is a graph representation of the difference between a subject portion profile and a sophisticated comparison model, according to aspects of the disclosure.

FIG. 4 shows a network of a subject, a device, an e-commerce server for a commercial website and a physical commercial store with an in-store server, according to aspects of the disclosure.

FIG. 5 is a process flow diagram illustrating a process to use a virtual body scanner application according to aspects of the disclosure.

FIG. 6 is a diagram illustrating a virtual body technology module, which includes a thermographic module and a platform image module, according to aspects of the disclosure.

FIG. 7 is another diagram illustrating the virtual body technology module working in tandem with the virtual body shopping module, according to aspects of the disclosure.

FIG. 8 is a process flow diagram illustrating a process to use a virtual body scanner application having a thermographic module according to aspects of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

According to an aspect of the disclosure, a virtual body scanner application is provided that allows a user to acquire accurate measurements in real-time with assistance of a camera and the use of a stored sophisticated comparison model that ensures that clothing, shoes, and accessories such as watches, bracelets, rings, necklaces fit the user precisely. The camera can take measurements of any portion of a subject, and a full-body photograph of the subject does not need to be taken. Therefore, a subject's torso, their hands, wrists, feet, and so on may be individually photographed or measured with a camera without having to do a fully body shot, due to the intelligence of the stored comparison model. The virtual body scanner application may be installed and used on a portable device such as a smart phone, tablet, or other such device that has an equipped camera or which may be coupled to a functional camera. The virtual body scanner application compares the visual data acquired via the camera to the sophisticated comparison model in order to efficiently derive measurement information about the user. This measurement information can then be provided to merchants, either online or in-store, who can provide products in a specific size that will fit the user. Because these product sizes are based on the derived measurement information, there will be a higher likelihood of consumer satisfaction and a less likely chance that products will be returned. This increases profits from the merchant's end, and also saves time and improves the shopping experience for consumers.

According to another aspect of the disclosure, a thermographic camera or a thermographic module within or associated with a camera, or thermographic software can process photographic data from a camera into heat signature information. Then, that heat signature information can be used to determine which parts of a photograph are the subject's and which parts belong to peripheral objects that are not the subject. For example, if the subject is a human being wearing a long-sleeved shirt, then the thermographic module would be able to discern between which areas of the photograph belong to the human being (the arm) and which areas of the photograph belong to peripheral objects that are not the human being (the long-sleeved shirt or other clothing that the human being may be wearing). Therefore, accurate measurements of just the human being or subject may be taken with this process.

According to another aspect of the disclosure, a small portion of the subject is captured by the image. This small portion is then enlarged in order to reach the dimensions of the real subject or object. This method allows the dimensions or measurements of the real object to be calculated. No matter how large or small the object is, this shrinking/expansion algorithm should be able to capture the dimensions of the real subject or object. The subject can also be different body parts or portions of a person. Using a camera, more than 30 different measurements can be acquired. With this shrinking/expansion algorithm, the proper dimensions of various objects can be determined efficiently.

In another aspect, the virtual body scanner application is an all-inclusive application that can take photographs of the overall body and any portion of the body at different angles (e.g., different body parts such as hands, feet), take into account the distance, and then use an algorithm to figure out the actual measurements. The calculated measurements can then be applied to different applications for retail, medical and everyday purposes. One example of such an application is virtual body scanning (VBS) shopping, or a virtual shopping network, e.g., if B=Business and C=Consumer, then the types of exchanges can be B2C, C2C and B2B. Individual consumers can also visualize products on themselves prior to purchase. This application is more in-depth that basic e-commerce applications currently available.

In another aspect, the virtual body scanner may use the various pixel data captured in a photograph for its measurement algorithm. A camera is used to take a photograph, which contains data in the form of pixels. From the photograph, various metrics and dimensions can be calculated (or are immediately apparent), such as dimension, shape, size and color. For example, from the photograph, basic software can be used to detect human skin due to thermographic or thermal imaging techniques. Techniques such as x-ray cameras may be used to see if there are objects through the walls. The thickness of clothing or other objects covering the human body may be calculated, in order to improve the accuracy of the initial measurements. The data calculated by pixel analysis on photographs can be used by shopping networks or other participants on the other side when they collect data. Just as an example, there is an existing object such as a watch, which contains pixel data of its own. This picture object can be transposed over an existing photograph of the user's hand in order to fit. The picture model of the object can also have different versions with different dimensions. The dimensions of the object model are calculated beforehand.

In another aspect, the virtual body scanning application can be applied to a number of different fields, including decorating/interior design, furniture, architecture, custom work, construction, or the arrangement of any set. For example, a medical application could be using the photographic algorithm to figure out the size of a foot cast for an orthopedic surgeon. Orthodontists or dentists can also use the photographic algorithm to calculate dimensions for things such as molds for braces on the teeth, for example. Physical therapists may use the photographic algorithm to calculate dimensions for back braces or any items that require fitting. Security applications can include using the photographic algorithm to calculate the dimensions of locks, doors or other security objects. Applications for animals include taking a photograph of a dog and using that photograph to calculate dimensions for dog clothing such as coats. For fashion, picture objects representing a new design can be thrown on top of photographs to roughly gauge fitting. Picture objects can represent a wide array of different wardrobe items such as clothing (denim jeans), hats, shoes, and accessories. Similar fashion and wardrobe concerns can be explored on the sets of films and TV shows. For example, wardrobe for characters can be tried on with photographs of the actors and without even having to have the actors participate. Also, if the user wished to design a piece of clothing or other product from scratch, then their designs could be applied to a virtual mannequin or other photographs taken of models or subjects. For architecture, different pieces of furniture can be moved around in a photograph of an empty building. For the CGI/SFX industries, 3D applications can be used to move around different objects based on photographs or photographed backdrops. Rough photographs can also serve as stand-ins for green screens when scenes are shot with green screens. Such photographic algorithms can also be used for post-production. For the supermarket industry, the photographic algorithm can be used to calculate volume (and eventually the weight) of food items to be purchased. This approach therefore skips the steps or necessity of weighing food before purchase.

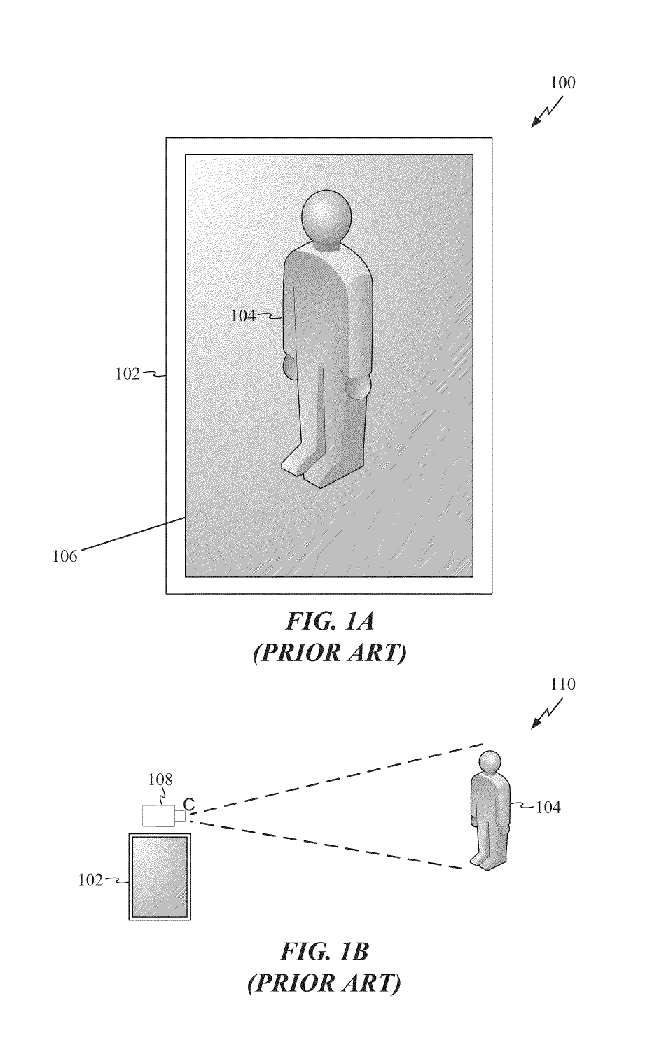

FIGS. 1A-1B show illustrations depicting a typical camera measurement procedure where a full-body shot of a subject 104 is taken with a device 102 having an equipped camera 108. In FIG. 1A, setup 100 shows a full-body subject 104 being viewed through a display window 106 of the device 102. The device 102 can be a smartphone, or tablet or other such device that has an equipped camera or which may be coupled to a functional camera. The display window 106 is essentially the “viewfinder” window of the camera for the device 102, and pictures taken in the display window 106 become actual digital photographs stored on the device 102 or in the camera, if the camera is separate from the device somehow. As can be seen in FIG. 1A, a full-body shot of the full-body subject 104 is taken in order for a typical measurement application to work.

In FIG. 1B, setup 110 shows a camera 108, which may either be equipped within the device 102 or be separate from, but still coupled to the device 102. Setup 110 also shows the full-body subject 104 being measured by the camera 108 in a full-body shot. The user taking the photograph can view the full-body shot of the full-body subject 104 through the display window 106 of the device 102 (as shown in FIG. 1A) and then take the picture.

This typical camera measurement process for taking a full-body shot of a full-body subject 104 is subject to a number of limitations. For example, the full-body subject 104 may be required to hold an object, such as a CD or DVD, for a more comprehensive understanding of the relative dimensions of the full-body subject 104. Taking the full-body shot might also be cumbersome because the full-body subject 104 may have to stay in one place for an extended period of time. The full-body subject 104 also has to undergo the extra effort of walking or moving to a point where their body can be seen in its entirety. Also, it is impossible for the subject to take a full-body photograph of himself or herself. Therefore, another volunteer or person is required in order to take a full-body shot of a subject. The subject can set a timer with the device 102, the camera 108 and a stand, and run to a pre-determined location where a full-body shot can likely be taken before the timer runs out. This approach, however, is inconvenient, time-consuming, requires additional work, and also subject to measurement error or imprecision.

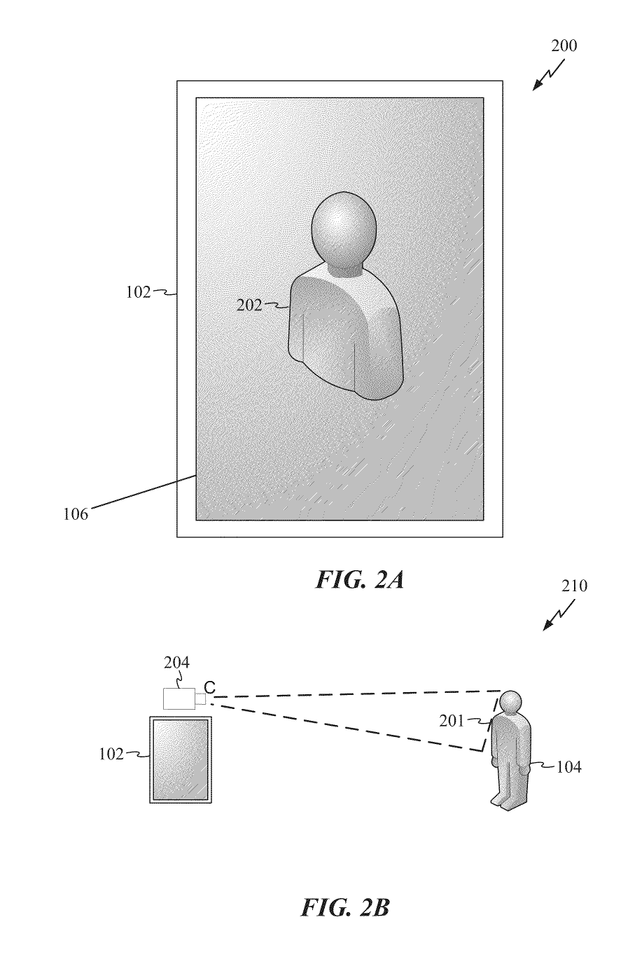

FIGS. 2A-2B show illustrations depicting a camera measurement procedure where any portion of a subject 202 is taken with a device 102 having a camera 204, according to aspects of the disclosure.

In FIG. 2A, setup 200 shows a subject portion 202 which can be seen within the display window 106 of the device 102. The subject portion 202 is any portion of the subject that can be viewed by a camera in the display window 106, and can be the subject's torso, face, hand, foot, wrist, thigh, and so on. For simplicity, the subject portion 202 is shown as a person's torso in FIG. 2A. As the device 102 with the camera 204 moves in different angles, it is able to capture different portions of the subject to make different subject portions 202.

In FIG. 2B, setup 210 shows a camera 204, which is either equipped within or separate from but coupled to the device 102, measuring just a visual portion 201 of a full-body subject 104. The measured visual portion 201 of the full-body subject 104 from the camera 204 becomes the subject portion 202 seen in the display window 106 of the device 102. Depending on the position and angle of the camera 204, and where the camera 204 can be moved, the visual portion 201 changes. Different visual portions 201 lead to different subject portions 202 being constructed, which is a significant convenience and allows measurements to be created for any portion of a subject, without the subject having to perform a full-body shot or be in a full-body setup.

The above-described camera measurement process using visual portions 201 and subject portions 202 brings about a number of advantages. For example, the subject can be anywhere, in any position (e.g., sitting down, lying down) and still be able to take an accurate photo to derive measurements. Furthermore, the subject can take accurate photographs of portions of himself/herself without having to rely on other people, or having to set up a timer or stand to walk into a full-body shot. Additionally, the subject is able to easily control the measurement accuracy of a shot by zooming in or zooming out with the camera 204. Additional photography conditions such as lighting, darkness and clarity can be easily adjusted by the subject without having to change anything about the camera 204 or the device 102. The subject can also easily move anywhere and still be able to use the camera 204 and the device 102 to take photographs against different backdrops, for example. The subject may also work with another person if it is desired to acquire difficult-to-reach shots. For example, say the subject wishes to photograph a portion of his/her back that is hard to reach. This can be easily achieved with the flexibility brought about by the visual portion 201 and subject portion 202 based camera measurement approach described above.

The camera 204 also has a position association with the device 102 in that the camera 204 can be within (embedded or positioned within) the device 102, or the camera 204 can be separate from or external to the device 102, but still coupled to the device 102 by a connection, the connection including a wired connection (e.g., a physical wire) or a wireless connection (e.g., 802.11 wireless connection, Bluetooth, 3G/4G, any connection not requiring a physical wire).

The camera 204 also can contain a thermographic module, or thermographic hardware module (not shown). The thermographic module can be within (embedded or positioned within) the camera 204 so that the camera 204 is a “thermographic camera”, or the thermographic module can be software or code that is stored within the camera 204. The thermographic module can also be hardware, software or a hardware/software combination that is separate from or external to the camera 204, but still coupled to the camera 204 by a connection, the connection including a wired connection (e.g., a physical wire) or a wireless connection (e.g., 802.11 wireless connection, Bluetooth, 3G/4G, any connection not requiring a physical wire).

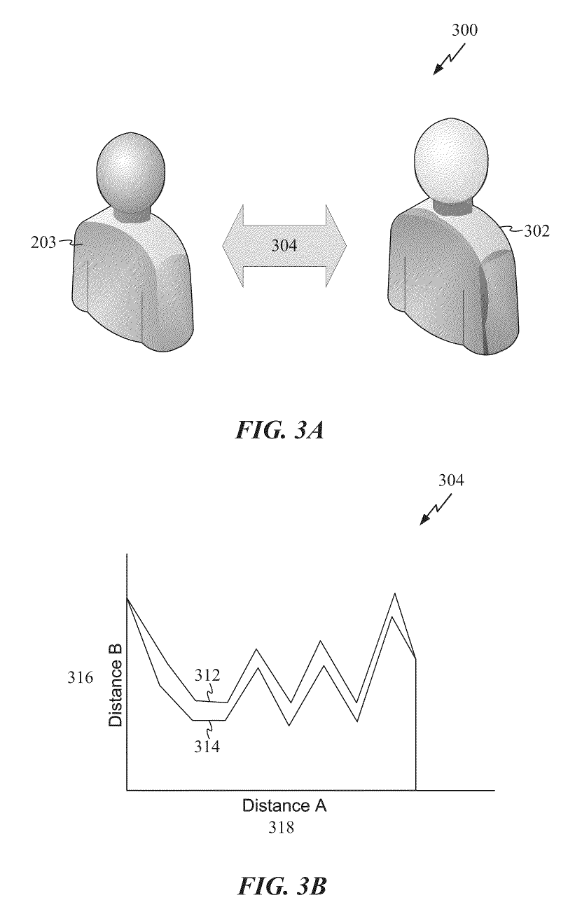

FIG. 3A shows a setup 300 where a sophisticated comparison model 302 is being compared to a subject portion profile 203, according to aspects of the disclosure. The sophisticated comparison model 302 is a stored mathematical computational model that includes a number of data points representing locations in 3D space. The subject portion 202, after being measured by a camera, is converted into a set of data points representing locations in 3D space—this is known as subject portion profile 203. The data points in the subject portion profile 203 are then compared, via comparison 304 to the data points in the sophisticated comparison model 302.

FIG. 3B is a graph representation of the comparison 304 between a subject portion profile 314 and a sophisticated comparison model 312, according to aspects of the disclosure. The comparison 304 can be viewed as a graph with the x-axis 318 being a distance metric, such as “distance A” and the y-axis being another distance metric, such as “distance B.” The distance metric is also used to measure locations in 3D space. The sophisticated comparison model 312 actually includes a number of different models, or different sets of data points representing locations in 3D space. Once measured, there is only one subject portion profile 314 and it remains fixed in value. During the comparison process, different models within the sophisticated comparison model 302 are applied in order to determine the difference between the current model and the subject portion profile 314. The model from the sophisticated comparison model 312 which yields the least difference between the subject portion profile 314 is selected. This model is then used to generate the fitting data.

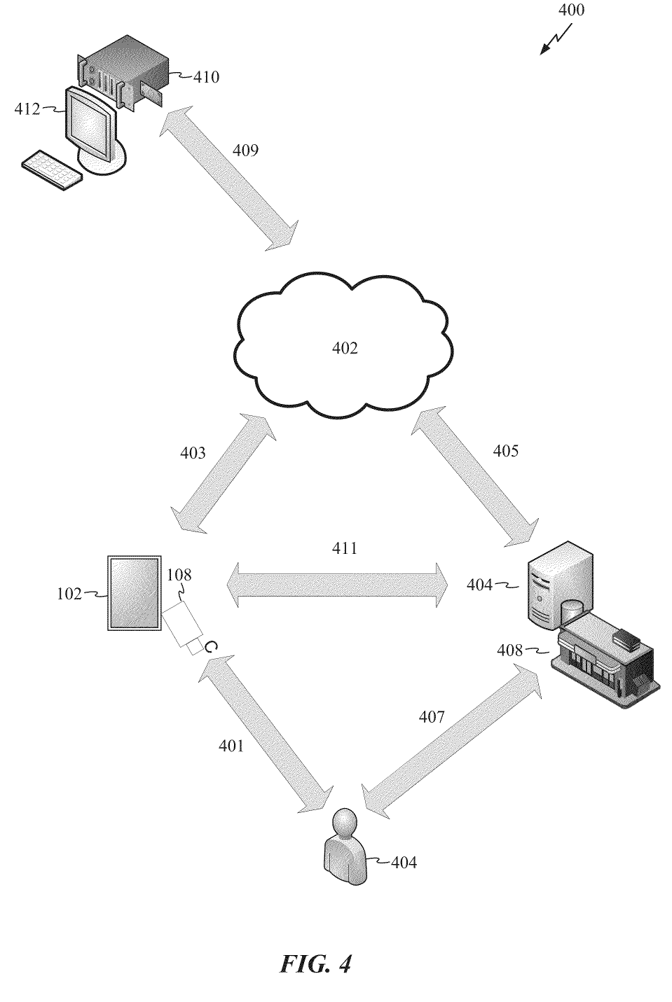

FIG. 4 shows a network 402 coupled to a subject 202, a device 102, an e-commerce server 410 for a commercial website 412 and a physical commercial store 408 with an in-store server 404, according to aspects of the disclosure. The network 402 is coupled via a device connection to the device 102, which may have a camera 204 equipped within it or coupled to it, if the camera 204 is separate from the device 102. The network 402 is also coupled via a store connection 405 to the in-store server 404, which is used by the physical commercial store 408. The network 402 is additionally coupled, via an e-commerce connection 409, to the e-commerce server 410 which is used by the commercial website 412. The camera 204 takes measurement results, via measurement link 401, from a subject 404 and derives fitting data from those measurements results. The subject 404 may also commute 407 to the physical commercial store 408 in order to purchase various commercial goods. The subject 404 may also carry its device 102 into the physical commercial store 408 and have the device 102 communicate, via the in-store connection 411, with the in-store server 404 by transmitting fitting data or other measurements. The device 102 may also transmit such fitting data to the in-store server 410 before entering the physical commercial store 408, or at a distance away from the physical commercial store 408. When the fitting data is transmitted in this way, the physical commercial store 408 already knows the size data of the subject and is able to conveniently provide merchandise in that size. The device 102 transmits fitting data and other measurements to the e-commerce server 410 and the commercial website 412 by the network 402. That is, the subject can browse the commercial website 412 on the device 102 and make purchases based on fitting data provided from the device 102. The subject may also download or transfer the fitting data from the device 102 into a computer, and use that computer to browse the commercial website 412 with the downloaded fitting data. The subject may also purchase merchandise over the commercial website 412 while at the physical commercial store 408, where the purchased merchandise can be picked up at the physical commercial store 408 instead of the customary approach of the merchandise being mailed to the subject.

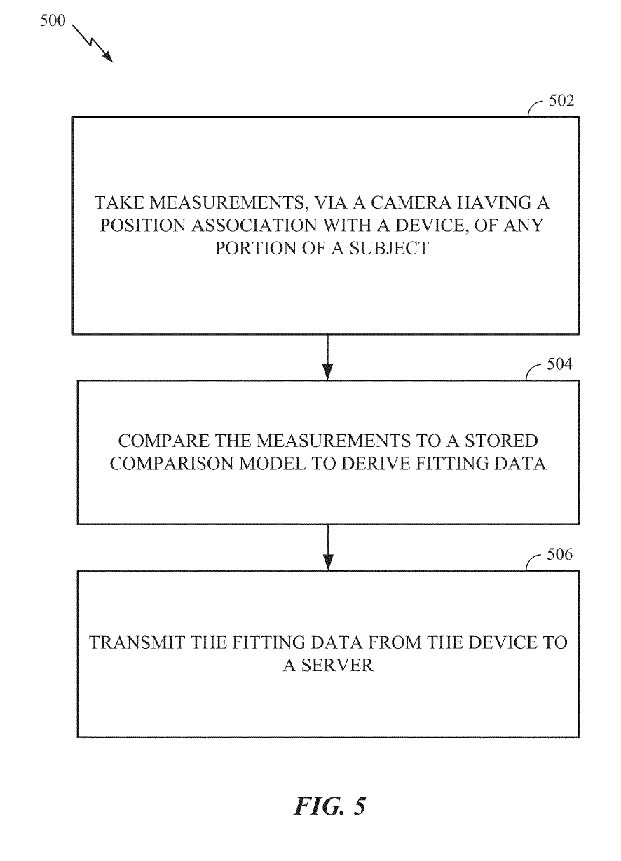

FIG. 5 is a process flow diagram illustrating a process 500 to use a virtual body scanner application according to aspects of the disclosure. In block 502, measurements are taken of any portion of a subject via a camera having a position association with a device. In block 504, the measurements are compared to a stored comparison model to derive fitting data. In block 506, the fitting data is transmitted from the device to a server.

In one implementation, the position association includes the camera within the device and the camera being separate from the device and coupled to the device via a connection, which can include a wired connection and a wireless connection. In one implementation, the stored comparison model includes a number of different models which are in turn fitted to the measurements to derive the fitting data. In one implementation, the server may be an e-commerce server or in-store server.

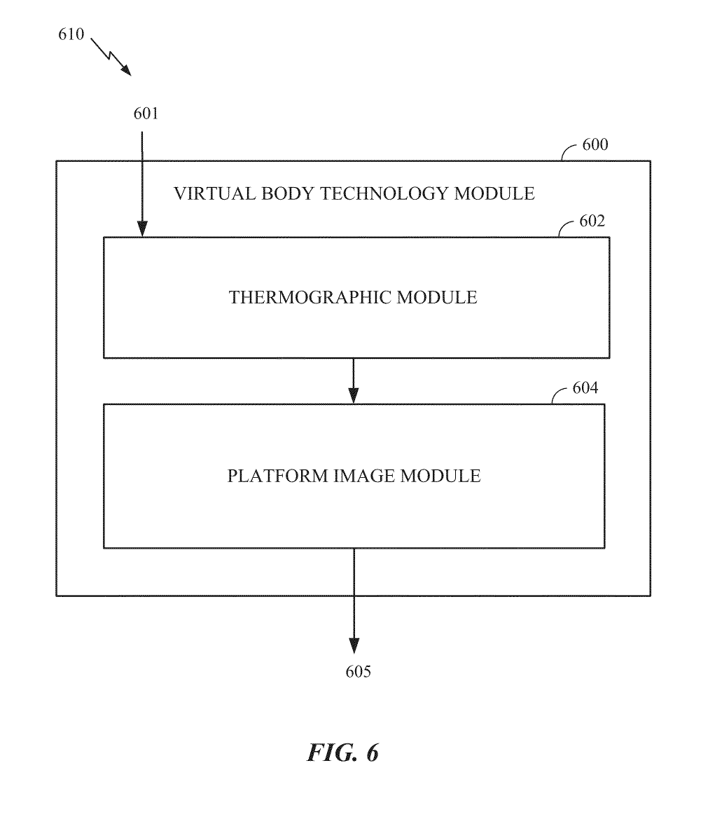

FIG. 6 is a diagram illustrating a virtual body technology module 600, which includes a thermographic module 602 and a platform image module 604, according to aspects of the disclosure. A photograph 601, which may be a single photograph or image or a series of photographs or photographic data or a series of images, is transmitted from a camera or another external device storing photographs, to the thermographic module 602 of the virtual body technology module 600. The virtual body technology module 600 is responsible for processing the data of photographs to derive fitting data. The thermographic module 602 has hardware and/or software functionality to transform the photograph into heat signature regions, and determine which heat signature regions correspond to a subject (e.g., human being) and which heat signature regions correspond to peripheral objects that are not the subject (e.g., inanimate clothing that the human being is wearing). Then, the thermographic module 602 can set the heat signature regions corresponding to the subject as a measured portion or measurement data, which is then transmitted to the platform image module 602. The platform image module 604 has hardware and/or software functionality similar to the operations discussed above where measurement data or a measure portion (from a photograph) is taken and then compared to various comparison models in order to derive fitting data. The platform image module 604 than sends that fitting data to the virtual body shopping module via connection 605—which usually goes to a server belonging to the virtual body shopping module, as discussed later.

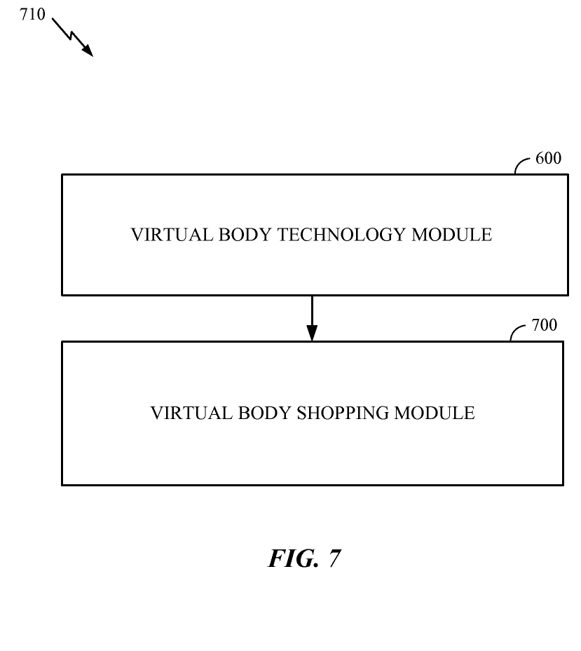

FIG. 7 is another diagram illustrating the virtual body technology (VBT) module 600 working in tandem with the virtual body shopping (VBS) module 700, according to aspects of the disclosure. Once the fitting data is derived from the VBT module 600, as described above, it is then processed by the VBS module, which takes that fitting data and then uses it to prove custom item/apparel selections that are custom-fitted for the user based on the fitting data. For example, if a user took a photograph of their waist in the VBT module, even if the user was wearing clothes obscuring their waist, the VBS module would have fitting data accurately covering the waist and would then use that data to send several custom-fitted apparel or items (e.g., such as belts, under-garments, pants, and so on) to the user on a website interface, for example, or in store, when the user goes shopping there with their fitting data already pre-sent.

For the VBT module 600, as soon as a picture is taken of a live person wearing clothes, that image will be processed through the thermographic module 602 and the platform image module 604 o calculate the specific size and area (as fitting data) of that person. Therefore, the exact measurements of the human body can be acquired and calculated, even if the person is wearing clothes that obscure the body.

For the VBS module 700, the fitting data will go to the VBS and send out to all the servers of all the companies participating in the program to source out the items matching the customer's request as well as their fitting data, which has been acquired via the VBT module 600. Then, the VBS module 700 will provide the customer with a list of items that actually fit the actual size dimensions of the customer accurately. The customer can double check if these items fit them by using a 3D model on a website to precisely visualize the look, for instance, or go into the store to physically try them on.

Therefore, an example data flow is from the customer (photograph) to running that photograph through the above-disclosed modules to derive (fitting data, which includes body specification and measurements) and also providing, via a customer, (item specifications such as color, brand, size), which then gets received by the VBS module 700, which then in turn gets sent to the companies. Then, the companies send back custom-fitted items through the VBS module 700, which get sent back to the customers, which can access those items via a website—to use a 3D model to see how they will look if they are remotely located from a physical store, or simply go into a physical store to try the items on.

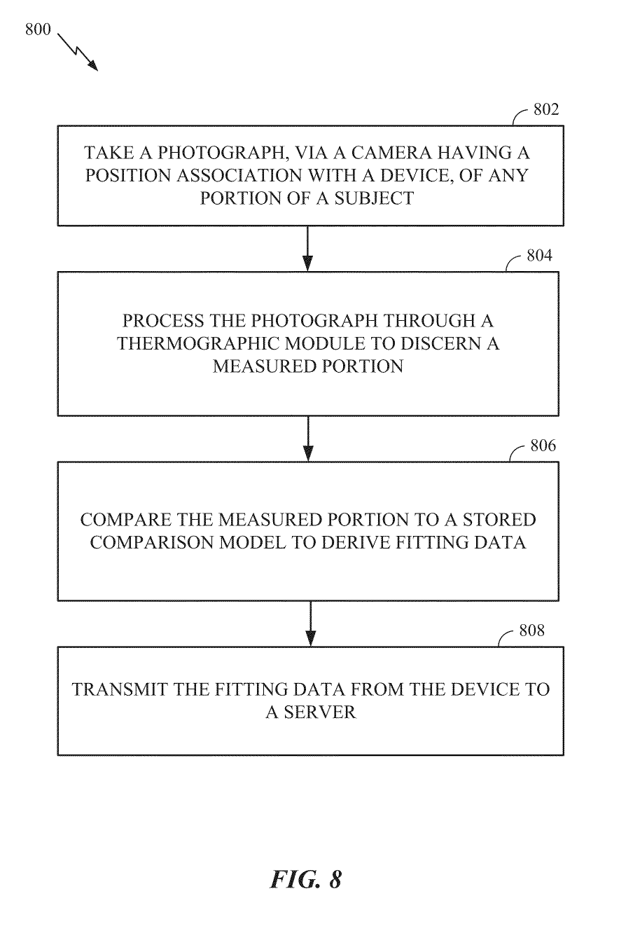

FIG. 8 is a process flow diagram illustrating a process to use a virtual body scanner application having a thermographic module according to aspects of the disclosure. In block 802, a photograph is taken of any portion of a subject via a camera having a position association with a device. In block 804, the photograph is processed through a thermographic module to discern a measured portion. In block 806, the measured portion is compared to a stored comparison model to derive fitting data. In block 808, the fitting data is transmitted from the device to a server.

In one implementation, any portion of the subject includes the subject's entire body, torso, lower portion, hips, feet, wrist, hand, arm, leg, waist, and face.

In one implementation, the position association includes the camera being within the device, and the camera separate from the device but still coupled to the device via a connection, the connection including a wired connection and a wireless connection.

In one implementation, processing the photograph through a thermographic module to discern the measured portion includes: transforming the photograph into different heat signature regions; determining which heat signature regions correspond to the subject and which heat signature regions correspond to peripheral objects that are not the subject; and setting the heat signature regions that correspond to the subject as the measured portion.

In one implementation, the stored comparison model comprises a plurality of comparison models and comparing the measured portion to the stored comparison module to derive fitting data includes: comparing the measured portion to each of the plurality of comparison models; finding the comparison model from the plurality of comparison models that is the closest to the measured portion; and using the closest comparison model as the derived fitting data.

In one implementation, the server includes an e-commerce server for use with a commercial website and an in-store server for use with a physical commercial store.

In one implementation, a wireframe model can be used based on pixel data. The various pixels that make up a photograph may be connected using wires in order to form a wireframe. This wireframe may be used as an enhanced tool to assist calculations or to improve the accuracy of calculations. The wireframe may also be wrapped around any human body part, the entire human body, and so on and so forth, in order to be able to store an accurate measurement model of a human being. Parts of that model may also be calculated at any time. For example, the dimensions of the human model's ear may be calculated.

In one implementation, a human body part such a hand can be captured within the display window of a device such as a smartphone or tablet. A picture object representing a product such as a watch may also exist, with the arrow indicating that the picture object can be moved over the hand and wrist for fitting. The hand and wrist may be a previously taken photograph that is still, or may be the live feed from a camera about to take a picture, or part of a video. Regardless, the picture object can be fitted over the hand and wrist in order to determine the best possible fitting.

In one implementation, a device such as a smartphone has a number of picture objects representing different clothing or wardrobe items in different sizes and measurements. These different picture objects can be applied to a backdrop photograph or video, such as a room (for architectural or furniture placement purposes) or a photograph of a human body or human body part such as an arm (for clothing fitting purposes). The measurements of the subject have already been taken by the photographic algorithm and forwarded to the relevant server. The server returns the picture objects in the proper size and dimensions that fit the provided measurement results. Therefore, the picture objects that can be moved around the subject photograph or video should fit.

In one implementation, a camera can be used to view hidden objects through a wall, for example. An experimental camera used to capture 3D images of objects and hidden things may be used, for example, such a camera is currently being developed at the Massachusetts Institute of Technology (MIT). The camera is also being used as an X-ray machine in the example provided. The camera may also emit laser pulses in 50-femtosecond pulses at various spots on the blockaded subject. The light pulses reflect off the obscured object and reflect back onto the blockaded surface. The camera is not an ordinary camera. It has a time resolution of 2 picoseconds. It collects scattered reflections and transfers them into a computer. The algorithm processes the data and reconstructs hidden objects within 15 millionths of a second. The MIT researchers suggest that this camera technology will see applications in high-cost military and search-and-rescue operations. Such camera technology may also be used with the virtual body scanner application as discussed above, in order to see hidden objects behind or within walls for architectural, military or medical applications.

In one implementation, a thermographic camera may also be used in the present disclosure. A thermographic camera, also called an infrared camera or thermal imaging camera, is a device that forms an image using infrared radiation. It is similar to a common camera that forms an image using visible light. Instead of the 450-750 nanometer range of the visible light camera, infrared cameras operate in wavelengths as long as 14,000 nm (or 14 μm).

In one implementation, a Venn diagram illustrating the colors that result when red, green and blue (RGB) intersect may be used for color detection or other purposes in the present disclosure. Yellow is formed when red and green intersect, magenta is formed when red and blue intersect, cyan is formed when blue and green intersect, and white is formed when all three colors, RGB, intersect. All the colors viewable in a thermographic camera can be formed with a RGB palette. In one implementation, the optical spectrum of viewable colors may be used when light is reflected off an object and into the eye. The eye interprets the different colors of an object when light is reflected off that object. The eye processor then acts as a filter in order to distinguish the different colors that get picked up from the white light. Take for example an image from a thermographic camera. From the image, a human hand can be seen having warmer colors. A piece of clothing covers the wrist of the human hand. A cold object, such as a cold-blooded insect, can be seen crawling on the human hand. Such thermographic camera technologies may be used with the above-described virtual body scanner or photographic algorithms in order to derive measurements.

In one implementation, images may be represented as pixels in the present disclosure. By representing images as pixels, analysis techniques in processing photographs can be performed. For example, a less-dense pixel photograph may not be used compared to a higher-density pixel photograph, which may be used. The difference in quality is immediately apparent, as the photograph version with more pixels can be viewed in a much higher quality. The more pixels there are in a given photograph, the more information is available to perform analysis.

In one implementation, a full-body model or picture of a human subject in pixels may be used in the present disclosure, the human subject rendered in pixels according to an x-y grid that charts coordinate information for each of the pixels that make up the human subject picture. In addition, the picture of the human subject can be seen as being made up of various pixels. Each pixel can have an (x,y) coordinate, as well as color information, or other individual pixel data such as depth, intensity, how black or white if only B&W is used, and so on. A close-up of a network of pixels with low resolution may have high granularity in that individual pixels may be seen. The same may apply to a network of many pixels with a high resolution. Photographs should be taken in the highest resolution possible in order to have enough information for accurate measurements. In another example of a portion of a human subject in an x-y grid, each of the pixels that make up the portion shot have an (x,y) coordinate, as well as color information, or other individual pixel data such as depth, intensity, how black or white a pixel is, if only B&W is used, and so on. As an example, various complex photographs of subjects or people may be represented with intricate pixel data.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A method to perform measurements, the method comprising:
taking a photograph, via a camera having a position association with a device, of any portion of a subject;
processing the photograph through a thermographic module to discern a measured portion;
comparing the measured portion to a stored comparison model to derive fitting data; and
transmitting the fitting data from the device to a server.

2. The method of claim 1, in which any portion of the subject comprises the subject's entire body, torso, lower portion, hips, feet, wrist, hand, arm, leg, waist, and face.

3. The method of claim 1, in which the position association comprises the camera being within the device, and the camera separate from the device but still coupled to the device via a connection, the connection comprising a wired connection and a wireless connection.

4. The method of claim 1, in which processing the photograph through a thermographic module to discern the measured portion comprises:
transforming the photograph into different heat signature regions;
determining which heat signature regions correspond to the subject and which heat signature regions correspond to peripheral objects that are not the subject; and
setting the heat signature regions that correspond to the subject as the measured portion.

5. The method of claim 1, in which the stored comparison model comprises a plurality of comparison models and in which comparing the measured portion to the stored comparison module to derive fitting data comprises:
comparing the measured portion to each of the plurality of comparison models;
finding the comparison model from the plurality of comparison models that is the closest to the measured portion; and
using the closest comparison model as the derived fitting data.

6. The method of claim 1, in which the server comprises an e-commerce server for use with a commercial website and an in-store server for use with a physical commercial store.

7. A method to perform measurements, the method comprising:
taking measurements, via a camera having a position association with a device, of any portion of a subject;
comparing the measurements to a stored comparison model to derive fitting data; and
transmitting the fitting data from the device to a server.

8. The method of claim 7, in which the stored model comprises a plurality of comparison models and in which comparing the measurements to the stored comparison model to derive fitting data comprises:
comparing the measurements to each of the plurality of comparison models;
finding the comparison model from the plurality of comparison models that is the closest to the measurements; and
using the closest comparison model as the derived fitting data.

9. A computer-program product, comprising:
a non-transitory computer-readable medium comprising code for:
taking a photograph, via a camera having a position association with a device, of any portion of a subject;
processing the photograph through a thermographic module to discern a measured portion;
comparing the measured portion to a stored comparison model to derive fitting data; and
transmitting the fitting data from the device to a server.

10. The computer-program product of claim 9, in which any portion of the subject comprises the subject's entire body, torso, lower portion, hips, feet, wrist, hand, arm, leg, waist, and face.

11. The computer-program product of claim 9, in which the position association comprises the camera being within the device, and the camera separate from the device but still coupled to the device via a connection, the connection comprising a wired connection and a wireless connection.

12. The computer-program product of claim 9, in which the code for processing the photograph through a thermographic module to discern the measured portion further comprises code for:
transforming the photograph into different heat signature regions;
determining which heat signature regions correspond to the subject and which heat signature regions correspond to peripheral objects that are not the subject; and
setting the heat signature regions that correspond to the subject as the measured portion.

13. The computer-program product of claim 9, in which the stored comparison model comprises a plurality of comparison models and in which the code for comparing the measured portion to the stored comparison module to derive fitting data further comprises code for:
comparing the measured portion to each of the plurality of comparison models;
finding the comparison model from the plurality of comparison models that is the closest to the measured portion; and
using the closest comparison model as the derived fitting data.

14. The computer-program product of claim 9, in which the server comprises an e-commerce server for use with a commercial website and an in-store server for use with a physical commercial store.

15. A device, comprising:
a camera configured to take a photograph, the camera having a position association with the device;
a thermographic hardware module coupled to the camera to process the photograph into measurement data;
an application hardware module coupled to the thermographic hardware module and the camera configured to compare information with a stored comparison model to derive fitting data, the information comprising the photograph and measurement data; and
an internet connection hardware module configured to transmit the fitting data to a server.

16. The device of claim 15, in which the position association comprises the camera being directly within the device and/or the camera separate from the device but still coupled to the device with a connection, the connection comprising a wired connection or a wireless connection.

17. The device of claim 15, in which the stored comparison model comprises a plurality of comparison models.

18. The device of claim 15, in which the thermographic hardware module comprises:
a heat signature module configured to transform the photograph into a heat signature photograph having different heat signature regions;
a determination unit configured to determine which of the different heat signature regions correspond to a subject and which of the different heat signature regions correspond to peripheral objects that are not the subject; and
a measurement module to set the heat signature regions corresponding to the subject as the measurement data.

19. The device of claim 18, in which the application hardware module comprises:
a comparison module configured to compare the information to each of the plurality of the comparison models;
a storage unit to store the comparison model from the plurality of comparison models that is closest to the information; and
a conversion module to convert the closest model to the fitting data.

20. The device of claim 16, in which the server comprises an e-commerce server for use with a commercial website and an in-store server for use with a physical commercial store.
